(19) United States
(12) Patent Application Publication
(10) Pub. No.: US 2006/0034175 A1
(43) Pub. Date: Feb. 16, 2006

(54) Transmission of data packets in containers

(76) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/533,718

(22) PCT Filed: Nov. 6, 2003
(86) PCT No.: PCT/IB03/04964

§ 371 Date: May 3, 2005

(30) Foreign Application Priority Data
Nov. 8, 2002 (DE) 102 52 533.1

(51) Int. Cl. H04L 12/26; H04B 7/005

(52) U.S. Cl. 370/236; 370/278

(57) ABSTRACT

In case a transmission of a MAC-hs PDU is aborted and all the RLC PDUs contained therein are discarded, delays may occur since these lost PDUs have to be retransmitted on RLC protocol level resulting in considerable delay since the Iub and Iur text interfaces have to be passed. According to an exemplary embodiment of the present invention, a transmission abortion is determined and a reduced number of data packets contained in the container which transmission has been aborted are put into another container provided with the same sequence as the proceeding aborted container and sent to the receiver. Advantageously, due to the fact that this second container may have a reduced amount of data packets contained and/or may have a reduced length, a probability that this second container is received error free at the receiving side is increased.

The present invention relates to the field of data transmission where data packets are transmitted from a transmitter to a receiver or exchanged between both. In particular, the present invention relates to a method of transmitting data packets from a transmitter to a receiver, to a data transmission system for transmitting data packets from a transmitter to a receiver, a transmitter for data transmission systems, to a receiver for a data transmission system and to a software program for performing a transmission of data packets from a transmitter to a receiver.

A method for transmitting data packets between a transmitter and a receiver as well as a corresponding data transmission system is, for example, described in 3GPP TS 25.308 V5.2.0 (2002-03), Technical Specification, 3rd Generation Partnership Project; Technical specification Group Radio Access Network; High Speed Downlink Packet Access (HSDPA); Overall description; Stage 2(Release 5) and 3GPP TS 25.321 V5,2.0 (2002-09) Technical Specification 3rd Generation Partnership Project; Technical Specification Group Radio Access Network; MAC protocol specification (Release 5), which are both hereby incorporated by reference.

According to this method, data is transmitted in the downlink, i.e. from the UMTS transmitter in the Node B to the receiver in the UMTS mobile station or UE (user equipment) via the high speed downlink shared channel (HS-DSCH) at high speed. In a sub-layer of the MAC layer, the so-called MAC-hs layer (hs: high speed), a HARQ retransmission protocol controls the retransmission of MAC-hs PDUs. At the receiver in the mobile station, the soft-bits of a retransmitted MAC-hs PDU are soft-combined with the soft-bits of an earlier transmission of this MAC-hs PDU. The MAC-hs layer is located on the Node B. The peer entities of the HARQ retransmission protocol are hence located on the Node B and the mobile station or UE.

In addition to the HARQ retransmission protocol, there is a second protocol, which is relevant in the context of the present invention: It is the so-called Radio Link Control (RLC) protocol, the peer entities of which are located on the mobile station's serving RNC (radio network controller) and the mobile station. For the details of the Radio Link Control protocol (RLC protocol) e.g. acknowledged mode (AM) and unacknowledged mode (UM) data transmission, 3GPP TS 25.322 V5.2.0 (2002-09) Technical Specification 3rd Generation Partnership Project; Technical Specification Group Radio Access Network, which is herewith incorporated by reference.

This RLC protocol is in charge of

performing segmentation of RLC SDUs (service data units, i.e. data units, which are received from the next higher layer above the RLC layer) into fragments, which are sent as part of an RLC PDU (protocol data unit, i.e. a data unit, which the RLC layer hands down to the next lower layer, which is here the MAC layer), and, if applicable, concatenation of different RLC SDUs or fragments of different RLC SDUs into RLC PDUs, and

(if configured accordingly) controlling retransmission of RLC PDUs, which the receiver indicates to the transmitter as not having been correctly received.

If data is transmitted via the HS-DSCH, this data is also always processed by an PLC protocol entity above the HARQ protocol, and this RLC protocol entity can then be configured for

Acknowledged mode (AM) data transmission, or

Unacknowledged mode (UM) data transmission.

“Acknowledged mode data” is also abbreviated by AMD, “Unacknowledged mode data” by UMD.

In both UMD and AMD transmission, the RLC PDUs have a sequence number, where UM prescribes 7 bits and AM prescribes 12 bits for coding the sequence number. This corresponds to a sequence number range from 0 to 127 for UM, and from 0 to 4095 for AM. If configured for AMD transmission, the RLC protocol performs segmentation (and, if applicable, concatenation) of RLC SDUs into RLC PDUs, and improves reliability of data transmission by performing retransmissions If configured for UMD transmission, the RLC protocol only performs segmentation and, if applicable, concatenation.

On the transmitting side, an RLC PDU is further processed by the MAC layer, or more precisely the MAC-d layer, which may add a MAC header, if logical channels have to be distinguished. This MAC header identifies the logical channel, on which the RLC PDU is transmitted. The MAC-d PDU (i.e. the protocol data unit produced by the MAC-d layer) is then delivered to the MAC-hs layer located on the Node B of the UMTS. Here, one or more MAC-d PDUs destined for the same mobile station are compiled into a MAC-hs PDU. These MAC-d PDUs may belong to different logical channels, i.e. have different MAC headers. Hence, the MAC-hs PDU multiplexes MAC-d PDUs of different logical channels, however, for the same receiving mobile station. In contrast to that, one MAC-d PDU always contains exactly one RLC PDU.

A MAC-hs PDU compiled from one or more MAC-d PDUs, is further processed by the physical layer. Generally, the data units, which the physical layer processes in the context of the HS-DSCH, are called transport blocks, i.e. a MAC-hs PDU is also a transport block, and the count of bits, which form the transport block (i.e. here the MAC-hs PDU), is called the transport block size. The physical layer processing of the transport block of type MAC-hs PDU is as follows:

The physical layer adds a cyclic redundancy check (CRC) sum (of 24 bit) and after this applies rate-1/3-turbo-coding to the bits of the transport block (of type MAC-hs PDU) and the CRC bits, i.e. adds parity bits resulting from the turbo coding, as described in 3GPP TS 25.212 V5.2.0 (2002-09), 3rd Generation Partnership Project; Technical Specification Group Radio Access Network; Multiplexing and channel coding (FDD) (Release 5), which is herewith incorporated by reference.

Furthermore, rate matching is applied, as described in TS 25.212 V5.2.0 , which adjusts the number of bits, which are output of the rate-1/3-turbo-coder to the number of bits, which can be transmitted within 2 ms via the air interface. The number of bits, which can be transmitted within 2 ms via the air interface, depends on the chosen number of channelization codes (1 to 15 can be used, and they all have a spreading factor of 16) as well as on the chosen modulation scheme, which can be QPSK (Quaternary phase shift keying) or 16 QAM (Quadrature Amplitude Modulation). E.g. the number of bits, which can be transmitted in 2 ms with 16 QAM, is by a factor of 2 bigger than the number of bits, which can be transmitted with QPSK.

Rate matching can e.g. mean puncturing, i.e. deleting pre-defined bits in the sequence of bits, which is output of the rate-1/3-turbo-coder, such that the resulting number of bits exactly fits the number of bits, which can be sent over the air interface within 2 ms. The receiving side knows the positions of the punctured bits, and considers them in the decoding process e.g. as bits with value zero.

If puncturing has to be applied, the forward error protection (FEC) necessarily becomes weaker than without puncturing. Puncturing may be avoided, e.g. if one or more additional channelization codes are used for the transmission over the air interface.

TS 25.212 V5.2.0 describes some further steps of the physical layer processing of a transport block of MAC-hs type, which are not important in the context of the present invention.

The period of 2 ms is also called the transmission time interval (TTI) of the HS-DSCH. Since it is equal to the periodicity, at which a transport block (of MAC-hs type) is transferred by the physical layer on the radio interface, it also corresponds to the inter-arrival time of a transport block (of MAC-hs type) at the physical layer, i.e. the time between consecutive deliveries of data between the MAC layer and the physical layer. In other words, the physical layer processes within a TTI of 2 ms a container of bits, i.e. the MAC-hs PDU bits, and is ready after 2 ms to process the next container of bits. In principle due to CRC attachment and channel encoding by means of turbo coding, the number of bits, which are then sent over the air interface, is greater than the number of bits of the container. If the number X of bits, which the physical layer can transmit over the air interface (after turbo encoding) within the TTI of 2 ms is kept fixed for two containers of different size (i.e. different number of bits), where the container sizes are smaller than X minus 24 (corresponding to the 24 CRC bits), the FEC of the smaller container is stronger than that of the bigger container, e.g. since less puncturing would be applied for the smaller container. Likewise, if a container of a given size S is transmitted after physical layer processing once with X bits (X>S+24) over the air interface, and once with Y>X bits over the air interface, the FEC is usually stronger, if Y bits are used for transmission over the air interface.

In the following the term “container” denotes the bits of the MAC-hs PDU, i.e. of the transport block of MAC-hs PDU type.

In accordance with the HARQ protocol in MAC-hs of the UMTS in release 5 as cited above, it is assumed to accept loss of a MAC-hs PDU (Protocol Data Unit, i.e. a data packet which is handed from a protocol layer to a underlying protocol layer) for which a maximum number of retransmissions was reached without success in the last retransmission, i.e. without being able to decode the received MAC-hs PDU error-free. In that case, the transmission of this MAC-hs PDU is aborted and all the RLC-PDUs contained in it are discarded. As a consequence, these lost RLC-PDUs have to be retransmitted on RLC protocol level (which means that retransmissions are performed by the RLC protocol, and that the retransmitted PDUs are the RLC PDUs) resulting in a considerable delay since the Iub and Iur interfaces between Node B and the DRNC and the DRNC and the SRNC, respectively, have to be passed. The DRNC is also referred to as drift RNC (Radio Network Controller). A mobile station which has left the serving area of its respective serving RNC (SRNC) is located in a cell served by another RNC. This other RNC may be then referred to as drift RNC of the considered mobile station.

It is an object of the present invention to avoid large delays in the transmission of data packets from a transmitter to a receiver.

According to an exemplary embodiment of the present invention as set forth in claim 1, a method is provided for transmitting first data packets from a transmitter to a receiver. The first data packets are transmitted in containers. Each of the containers is provided with a sequence number. For example, the sequence numbers may be consecutive numbers marking consecutive containers. According to this exemplary embodiment of the present invention, a transmission abortion is determined where a transmission of a first container, which comprises a first number of second data packets of the first data packets, is aborted. For example, an abortion may be determined when a maximum number of retransmissions of containers was reached without success, i.e. without the receiver being able to error-free decode information contained in the data packets in the container, in the last transmission. The first container was provided with a first sequence number. A second number of third data packets is selected from the first number of second data packets such that the first number is larger than the second number. Then a second container is formed comprising the second number of third data packets, and this second container is transmitted to the receiver with the first sequence number.

In other words, out of the second data packets in the first container a smaller number of third data packets is selected then put in another container which is provided with the same sequence number as the aborted container. Due to the fact that the second container contains a smaller number of data packets, this container may be provided with a stronger forward error correction (FEC) for example such that a lower puncturing is applied and hence more parity bits are transmitted. The data packets may be MAC-d PDUs and the containers may be MAC-hs PDUs as described in 3GPP TS 25.308 V5.2.0 (2002-03), Technical Specification, 3rd Generation Partnership Project; Technical specification Group Radio Access Network; High Speed Downlink Packet Access (HSDPA); Overall description; Stage 2 (Release 5) and 3GPP TS 25.321 V5.2.0 (2002-09) Technical Specification 3rd Generation Partnership Project; Technical Specification Group Radio Access Network; MAC protocol specification (Release 5), which are herewith incorporated by reference.

This may provide for a faster overall data transmission of data packets from the transmitter to the receiver. Also this may allow reduction of delays in the retransmission of faulty containers.

According to another exemplary embodiment of the present invention as set forth in claim 2, fourth data packets, namely data packets included in the aborted container, which were not sent with the subsequent container with the same sequence number, are deleted.

This may allow for an efficient control strategy for retransmissions in particular, for example, in a HARQ retransmission protocol, especially if there is a further retransmission protocol on top of the HARQ retransmission protocol, e.g. such as the RLC protocol in UMTS.

According to another exemplary embodiment of the present invention as set forth in claim 3, the aborted container has a weaker forward error correction (FEC) than the new container, i.e. the number of parity bits in the new container is bigger than the number of parity bits in the aborted container.

Due to the reduced length of the second container (resulting in a stronger FEC), a probability that the second container is received error free at the receiver in comparison to the probability that the first receiver is received error free at the receiver, is higher.

According to another exemplary embodiment of the present invention as set forth in claim 4, the third data packets are selected from the second data packets in accordance with an order of the second data packets with which they were arranged in the aborted container.

According to another exemplary embodiment of the present invention as set forth in claim 5, the third data packets are selected from the second data packets in accordance with an urgency with which they are required at the receiver.

According to yet another exemplary embodiment of the present invention as set forth in claim 6, the data packets are segmented from service data units of a higher protocol layer or in other words service data units with respect to a higher protocol layer. The third data packets are selected such that the service data units of a higher protocol layer may be rebuilt or reconstructed at the receiver from the data packets received in the containers.

According to another exemplary embodiment of the present invention as set forth in claim 7, these third data packets are selected such that they belong to the same service data units of a higher protocol layer for which data packets have been received within an earlier container, i.e. with a container having a lower sequence number.

According to another exemplary embodiment of the present invention as set forth in claim 8, the third data packets in the second container are selected from the second data packets at random.

According to another exemplary embodiment of the present invention as set forth in claim 9, the third data packets are selected from the second data packets such that a loss of synchronization at the receiver is avoided. For example, the third data packets may be selected such that for example it is avoided that the peer RLC entities on the transmitter side and the receiver side lose the HFN (Hyper Frame Number) synchronization, i.e. do not increment at the correct point-in-time the most significant bits of the serial number, which forms the time varying input of the algorithm for ciphering and deciphering.

According to another exemplary embodiment of the present invention as set forth in claim 10, the third data packets are selected such that a number of logical channels affected by the reduction of the amount of data packets in the second container is minimized.

According to another exemplary embodiment of the present invention at set forth in claim 11, data packets contained in the first container which have not been sent with the second container are transmitted to the receiver in a third container having another sequence number. Preferably this sequence number is a number subsequent to the sequence number of the second container.

According to another exemplary embodiment of the present invention as set forth in claim 12, the method is applied for a control of retransmission of the HARQ protocol on the high speed downlink shared channel in UMTS.

According to another exemplary embodiment of the present invention as set forth in claim 13, a data transmission system is provided where out of the second data packets contained in the first container, the transmission of which was aborted, a second container is compiled from a smaller number of second data packets as the first container. Also according to an aspect of this exemplary embodiment of the present invention, the second container may have a smaller size than the first container. For this smaller container which contains a reduced number of second data packets, the chances for a successful transmission are higher while it may be accepted that the remaining data packets, i.e. the second data packets contained in the first container but not resent with the second container, are lost. According to an aspect of this exemplary embodiment of the present invention, these remaining data packets may be retransmitted on RLC protocol level.

According to another exemplary embodiment of the present invention as set forth in claim 14, a transmitter for a data transmission system is provided allowing for a resending of second data packets in a way such that selected ones of the second data packets are sent to the receiver.

According to another exemplary embodiment of the present invention as set forth in claim 15, a receiver for a data transmission system is provided which is adapted to receive a container including a number of data packets which is smaller than a number of data packets contained in a preceding container. The received container has the same sequence number as the preceding container.

According to another exemplary embodiment of the present invention as set forth in claim 16, a computer program is provided for a data processor for example in a data transmission system for performing a transmission of first data packets from a transmitter to a receiver. The computer program according to the present invention is preferably loaded into a working memory of the data processor. The data processor is equipped to carry out the method of the present invention as, for example, described in claim 1. The computer program may be stored on a computer readable medium, such as a CD-ROM. The computer program may also be presented over a network, such as the World Wide Web and can be downloaded into the working memory of the data processor from such a network.

It can be seen as the gist of an exemplary embodiment of the present invention that a number of data packets is selected from data packets contained in a container, the transmission of which is aborted and resent in another container having the same sequence number as the aborted container. The number of data packets in this second container is smaller than the number of data packets in the aborted container. Also the second container may have a smaller length than the aborted container. The second container may also be provided with a stronger FEC, for example because the number of bits to be punctured in a rate matching stage after error correcting encoding is smaller. Furthermore, a selection of the data packets from the data packets contained in the aborted container may be optimized, for example in terms of RLC SDUs. For the second container including a reduced number of packets or having a smaller size, the chances for a successful transmission are higher. According to an aspect of the present invention it is accepted that the remaining data packets which have not been selected for retransmission in the second container are lost and have to be retransmitted, for example on RLC protocol level. Such successive reduction of the container size may be applied further until finally a container can be transmitted successfully. By this, the number of data packets transmitted using retransmission functionality, for example on a MAC-hs level is maximized.

These and other aspects of the present invention will become apparent from and elucidated with reference to the embodiments described hereinafter.

Exemplary embodiments of the present invention will be described in the following, with reference to the following drawings:

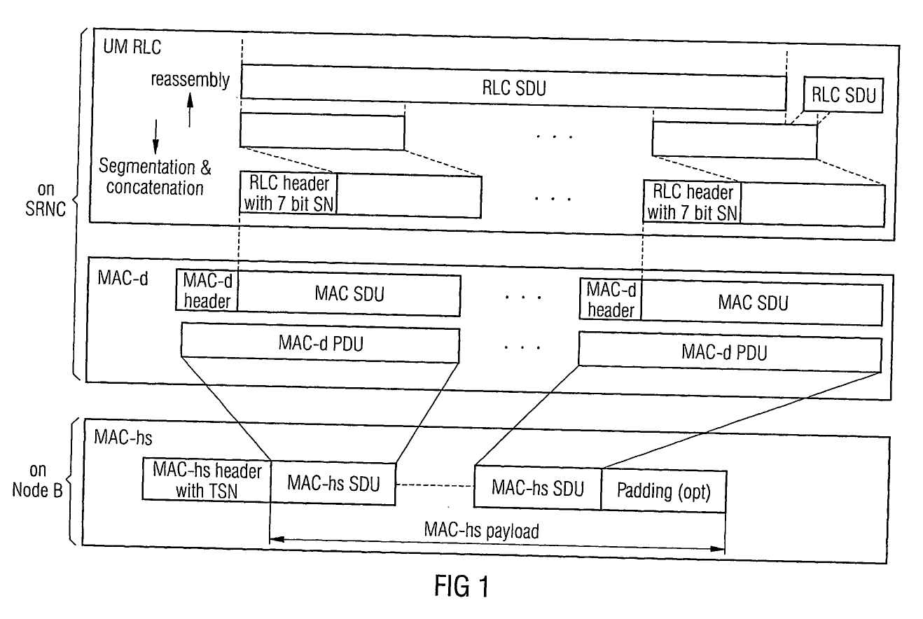

FIG. 1 shows an exemplary embodiment of layers of a transmitter or receiver of a data transmission system according to the present invention.

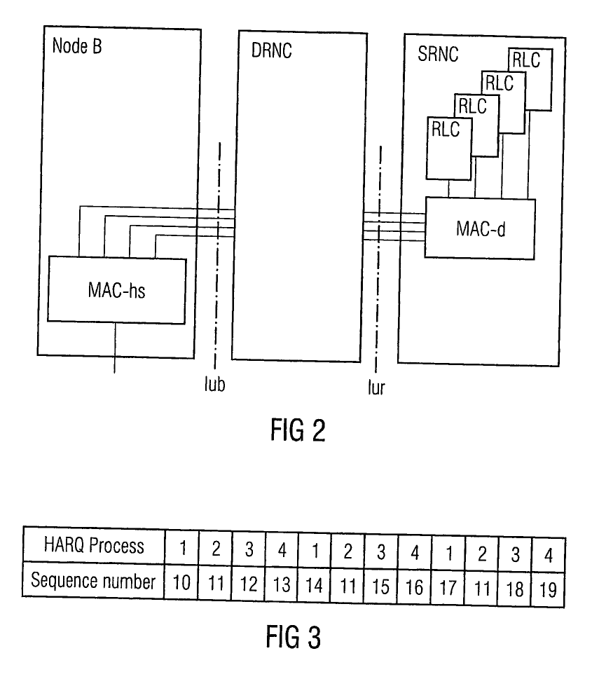

FIG. 2 shows a simplified representation of Node B, DRNC and SRNC as may be used in the data transmission system according to the present invention.

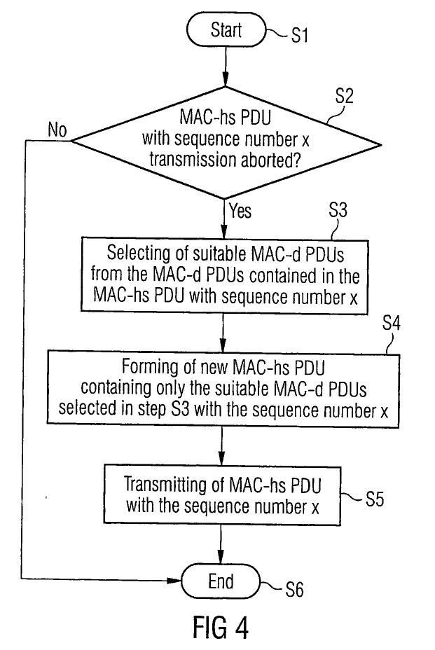

FIG. 3 shows an example of HARQ process identities and sequence numbers of containers transmitted between the transmitter and the receiver according to the present invention.

FIG. 4 shows a simplified flowchart of a method according to the present invention.

FIG. 1 shows a simplified representation of layers of a transmitter or a receiver according to exemplary embodiments of the present invention as they may be applied in an exemplary embodiment of a transmission system according to the present invention. According to a preferred embodiment of the present invention, the data transmission system and therewith the transmitter and receiver according to exemplary embodiments of the present invention are arranged in accordance with 3GPP TS 25.308 V5.2.0 (2002-03), Technical Specification, 3rd Generation Partnership Project; Technical specification Group Radio Access Network; High Speed Downlink Packet Access (HSDPA); Overall description; Stage 2 (Release 5) and 3GPP TS 25.321 V5.2.0 (2002-09) Technical Specification 3rd Generation Partnership Project; Technical Specification Group Radio Access Network; MAC protocol specification (Release 5), which are hereby incorporated by reference.

In accordance with the above technical specifications, in the HS-DSCH (High Speed Downlink Shared Channel) different container sizes are defined. In other words, the container size denotes the number of bits, which the physical layer receives from the MAC layer and which are then transmitted via the air interface after CRC attachment, and error correcting encoding including an addition of parity or error protection bits and rate matching as defined in the above technical specifications. In case there are good channel conditions on the radio channel, a relatively large container may be transmitted error-free with a high probability from the transmitter to the receiver. However, in case there are difficult or bad channel conditions, a small container size has to be selected in order to maximize the probability of a successful transmission.

In the RLC protocol on the RNC (Radio Network Controller), data packets such as RLC SDUs (service data units), which were received from the layer above the RLC layer, are segmented into parts having a predetermined segmentation size. In general, a service data unit (SDU) of a considered protocol layer is defined in the relevant literature as a data unit, which this considered protocol layer receives from the next higher protocol layer. The considered protocol layer processes the SDU, which in case of the RLC protocol means e.g. that the SDU is segmented into fragments. As a result of the protocol processing, the SDU is transformed into one or more PDUs (protocol data units), which in case of the RLC protocol then e.g. contain each one fragment of the segmented SDU. These fragments are provided with an RLC header, which contains at least a sequence number, and then form the payload or content of an RLC PDU. In general, PDUs of a considered protocol layer are defined as the data units, which the considered protocol layer delivers to the next lower protocol layer. These RLC PDUs are processed in the MAC-d layer in which they may, for example, be provided with a MAC header. Then the RLC PDUs (with or without MAC header) are handed as MAC-d PDUs to a subjacent protocol layer. In case of a data transmission via the HS-DSCH, this subjacent protocol layer is the MAC-hs layer which, as may be taken from FIG. 2 is located on the Node B.

As may be taken from FIG. 1, the MAC-hs layer processes the received MAC-d PDUs which respectively contain exactly one RLC-PDU (FIG. 1 considers the case of UM, the same holds for AM) and puts them in MAC-hs PDUs for transmission via the HS-DSCH, and then via the radio interface or air interface. For example, the MAC-hs layer may decide on the basis of a channel quality estimation which container size, i.e. which MAC-hs PDU size should be selected for the next MAC-hs PDU which is sent on the HS-DSCH via the air interface. Given the RLC-PDU size (which then also determines the size of the respective MAC-d PDU) a MAC-hs PDU may, depending on the selected size of the container, contain a plurality of MAC-d PDUs (and therewith RLC-PDUs).

The segmentation size is given by the so-called RLC PDU size minus the bits for the header of the RLC PDU. The size of the MAC-d PDU may be determined from a sum of the RLC PDU size, and the size of the MAC header. In the other channels, except for the HS-DSCH, the size of a MAC-d PDU is usually identical to the container size, whereas in the case of the HS-DSCH, this requirement of the identical size does not exist. Rather, in the HS-DSCH, the size of the MAC-hs PDU corresponds to the container size, and the MAC-hs PDU can consist of several MAC-d PDUs.

The container size or MAC-hs PDU size to be used for transmitting a MAC-hs PDU via the HS-DSCH has to be adjusted according to the current channel conditions, i.e. for good channel conditions the container size can be big, while it has to be small for bad channel conditions, in order to achieve a reasonably high probability for achieving an error-free transmission of the MAC-hs PDU. For the following reasons, it is usually not possible to change the RLC PDU size in AM or UM in order to take the channel conditions into account.

When transmitting data packets in AM, where retransmissions are performed in containers with sequence numbers ranging from 0 to 4095, the size of the RLC-PDU may only be varied or changed by means of a relatively time consuming reconfiguration of the transmitter side and receiver side RLC machines or RLC entities. Such a reconfiguration may take between 100 and 200 ms. When transmitting data packets in UM, where no retransmissions are performed and the containers are used having sequence numbers ranging from 0 to 127, the size of the RLC PDU may be modified without such a time consuming reconfiguration. However, the RLC protocol in the UTRAN is located on the RNC which is generally connected to the Node B via a DRNC. A DRNC is a drift RNC. In this case, as may be taken from FIG. 2, two interfaces have to be passed: namely, Iur, which is located between the SRNC and DRNC, and Iub, which is located between the DRNC and the Node B. This may cause delays.

Furthermore, usually for transmitting data from the RNC to the Node B, half the round trip time is required. The full round trip time relates to the time from the transmission of data from the RNC to a UE or mobile station until the receipt of a response in the RNC. Usually, the full round trip time is in the range of 100 ms (in the worst case). In other words, a data transmission between the RNC and the Node B may require up to 50 ms. Due to this long data transmission time, the RLC PDU size may not be changed very rapidly in the case of UM data transmission. A control message sent from the Node B to the SRNC which would indicate to the respective RLC machine on the SRNC that from now on, for example, a doubled RLC PDU size may be possible, would reach the RLC machine only after up to 50 ms. Also it would require another time duration of up to 50 ms until the RLC PDUs (packed into a MAC-d PDU) having this changed size are received in the MAC-hs layer.

Since, however, the radio channel may drastically change much faster, an adjustment of the container size, i.e. the size of the MAC-hs PDUs to the actual channel conditions has to be accomplished as fast as possible by changing the RLC PDU size for UM or AM. Otherwise, the amount of retransmissions on the MAC-hs level increases significantly when the container size is selected too big due because the RLC PDU size of one or more RLC PDUs to be carried in the container was chosen too big.

Due to the reasons described above, it may also be advantageous to choose the RLC PDU size in acknowledged mode (AM) as well as in unacknowledged mode (UM) such that a single RLC PDU or a very small number of RLC PDUs may be accommodated in the smallest container, for which a reasonably high probability of a successful transmission can be assumed, also in very bad channel conditions.

In the technical specifications indicated above, in particular in TS 25.321 V5.2.0 , the container size is suggested such that approximately 70 containers of the smallest possible container size may fit into one container of the largest possible container size.

In accordance with the above indicated technical specifications, the HARQ protocol does not allow that after abortion of a transmission of a MAC-hs PDU (for example because of reaching a preset maximum number of retransmissions) this MAC-hs PDU is split into two or more MAC-hs PDUs. Furthermore, none of the above references indicates or suggests that these two or more smaller MAC-hs PDUs are subsequently sent one after the other. This is, for example, not possible with the HARQ protocol, as described in the above references, since MAC-hs PDUs are provided with subsequent sequence numbers and are then quasi-parallel transmitted on a plurality, for example, four, HARQ processes.

This is further explained with reference to FIG. 3. The upper line of FIG. 3 shows the identities of the respective HARQ process with which the MAC-hs PDUs are transmitted and the lower line indicates sequence numbers with which the respective MAC-hs PDUs are provided.

As may be taken from FIG. 3, in case the MAC-hs PDU provided with the sequence number 11 which is transmitted via the second HARQ process, requires more than two retransmissions, the MAC-hs PDUs transmitted on the other HARQ processes are always successfully transmitted. This situation yields the sequence of sequence numbers as indicated in FIG. 3.

In the case the transmission of the MAC-hs PDU 11 is finally aborted after the second retransmission, in accordance with the above references, the content of the MAC-hs PDU 11 may not be segmented into smaller fragments which are then transmitted in several MAC-hs PDUs anew on HARQ protocol level since there is only one sequence number between 10 and 12, and the MAC-hs PDUs with sequence number 10 and 12 might already have been received on the receiving side.

Usually, the reason for the abortion of the transmission on the MAC-hs level is the size of the MAC-hs PDU which has been selected too big in relation to the actual channel conditions. If a smaller MAC-hs PDU had been selected, the chances of a successful transmission would have been much higher.

Due to the above-described problems, according to the above mentioned technical specifications, transmission of a MAC-hs PDU is aborted in case a maximum number of retransmissions has been reached, and the contained MAC-d PDUs are all deleted in Node B. All MAC-d PDUs (or more precisely the RLC PDUs contained in the MAC-d PDUs) are then retransmitted on RLC protocol level. This may cause a plurality of disadvantages:

Problems which may occur in AM:

Due to the retransmission of the MAC-d PDUs contained in the aborted MAC-hs PDU on RLC protocol level, as described above, delays may be caused which are in particular disadvantageous for streaming services.

A retransmission of the RLC PDUs contained (as MAC-d PDUs) in the aborted MAC-hs PDU on RLC protocol level is less effective than a retransmission of these MAC-d PDUs on HARQ protocol level.

Problems which may occur in UM:

Due to the deletion of all MAC-d PDUs which are contained in an aborted MAC-hs PDU, it may appear that RLC PDUs are deleted which are still required at the receiving side, for example, at the receiver for assembling an RLC-SDU from RLC PDUs which have already been received. Due to this, these RLC PDUs, which have been received earlier on and belong to an RLC-SDU, which can no longer be re-assembled, may be useless, and the resulting disturbance is a loss of a full RLC SDU rather than just a few RLC PDUs.

Due to the loss of a plurality of big MAC-hs PDUs in succession, the synchronization of the HFN incrementation between the transmitting and receiving RLC entities may be lost with the effect that the receiving RLC entity can no longer decipher the received RLC PDUs correctly, i.e. from then on data exchange is no longer possible.

According to an exemplary embodiment of the present invention, the problems or delays described above may be overcome without changing the HARQ protocol as described in the above references as explained in the following.

According to a first aspect of the present invention, in case a transmission of a MAC-hs PDU has to be aborted, the scheduler of data transmission via the HS-DSCH, which scheduler is located in the MAC-hs layer on the Node B, generates another container, i.e. a second MAC-hs PDU containing a selection of MAC-d PDUs from the MAC-hs PDU which has been aborted. Preferably, the amount of MAC-d PDUs contained in the second MAC-hs PDU is smaller than that in the aborted MAC-hs PDU. Hence, the new MAC-hs PDU has a shorter length so that the FEC applied by the physical layer is stronger. The second MAC-hs PDU is sent with the same sequence number as the aborted MAC-hs PDU. The MAC-d PDUs which are contained in the first MAC-hs PDU (which has been aborted) and are not contained in the second MAC-hs PDU, are deleted. According to an aspect of the present invention, the deletion of these remaining MAC-d PDUs is accepted. In some cases, it may be possible to retransmit these remaining MAC-d PDUs also by the HARQ protocol, but in most cases a retransmission of these remaining MAC-d PDUs may have to be performed on RLC protocol level. This implies that the RLC PDUs are AM RLC PDUs.

The selection of the MAC-PDUs to be transmitted in the second MAC-hs PDU may be optimized. For example, a selection of the MAC-d PDUs for a further transmission within the second MAC-hs PDU may be such that they are selected in accordance with the order of the MAC-d PDUs as they have been arranged in the aborted MAC-hs PDU. For example, the first half of the MAC-d PDUs contained in the aborted MAC-hs PDU may be sent in the second MAC-hs PDU, while the other half of these MAC-d PDUs is discarded. As indicated above, the second MAC-hs PDU is then transmitted to the receiver side with the same MAC-hs sequence number as the aborted MAC-hs PDU. This is possible since due to the abortion of the transmission or retransmission of the original MAC-hs PDU, the soft buffer on the receiving side, which buffer contained (until the abortion) the soft bits of the original MAC-hs PDU, has been flushed, so that the reordering entity has not yet received a MAC-hs PDU with the considered sequence number as, for example, described in the above indicated technical specifications. The reordering entity is detailed in TS 25.321.

The remaining MAC-d PDUs which were not sent in the second MAC-hs PDU, but which were contained in the original MAC-hs PDU, have to be deleted. Thus, in the case of AM, these remaining MAC-d PDUs have to be resent on RLC protocol level. In the case of UM they are finally lost. However, they may also, for example, be retransmitted on application level.

Due to the decreased number of MAC-d PDUs in the second MAC-hs PDU and/or due to the smaller size of the second MAC-hs PDU, the probability of a successful transmission is increased. Due to this, statistically, the possible transmission rate may be increased and delays may be avoided.

As indicated above, the selection of MAC-d PDUs to be retransmitted in the second MAC-hs PDU should be performed in a way that is optimal, for example, for the receiving side. According to an aspect of this exemplary embodiment, the selection may, for example, be performed as already indicated above in accordance with an order according to which they were arranged in the original MAC-hs PDU. In other words, for example, when m MAC-d PDUs may be contained in the second (smaller) MAC-hs PDU, the first m MAC-d PDUs of the original MAC-hs PDU may be selected.

Furthermore, according to another exemplary embodiment, the selection of the MAC-d PDUs to be contained in the second MAC-hs PDU, may be performed at random.

Also, the selection of the MAC-d PDUs to be retransmitted in the second MAC-hs PDU may be performed such that the MAC-d PDUs are selected which are most urgently awaited at the receiving side. According to one aspect of the present invention, these most urgently awaited MAC-d PDUs may be MAC-d PDUs which are contained in RLC-PDUs belonging to RLC-SDUs for which the receiving side has already received RLC-PDUs and which MAC-d PDUs are therefore required at the receiving side for reconstructing the RLC-SDUs. In case such MAC-d PDUs are selected, the data rate of the HS-DSCH transmission may be maximized.

The scheduler may recognize these MAC-d PDUs belonging to RLC SDUs for which RLC PDUs have already been received at the receiving side by analyzing for each logical channel the RLC length indicators together with the RLC sequence number contained in the RLC PDUs. For this, the scheduler has to know about the meaning of the length indicator. Since the length indicators are ciphered together with the RLC PDU payload (while RLC sequence numbers are not ciphered), evaluating the length indicators may only be possible, if no ciphering is applied for the RLC PDUs carried on the considered logical channel.

Since in UM, in case of a loss of an RLC PDU, the RLC SDU for which fragments are contained in the lost RLC PDU is deleted at the receiving side, logical channels, which transmit unacknowledged mode RLC PDUs (UM logical channels) are, according to an aspect of the present invention, preferred in comparison to logical channels transmitting acknowledged mode RLC PDUs (AM logical channels), even if UM logical channels have a lower MLP (MAC Layer Priority) than the AM logical channels.

According to another aspect, the most urgently required MAC-d PDUs are such MAC-d PDUs in UM, the loss of which would cause an RLC machine to lose the HFN (Hyper Frame number) incrementation synchronization. For example, the loss of HFN incrementation synchronization of an RLC machine may be caused by the fact that due to a partial transmission of a preceding MAC-hs PDU an already significant amount of UM RLC PDUs (up to almost 128) of a particular UM logical channel, are lost. The scheduler may derive from the MAC headers of each processed MAC-d PDU, which MAC-d PDU and (since one MAC-d PDU contains exactly one RLC PDU) which RLC PDU relates or belongs to the same logical channel, and also to which logical channel it belongs. Thus, according to an aspect of the present invention, the scheduler determines which MAC-d PDU of a logical channel has most urgently to be transmitted by reading the RLC header of each RLC PDU (contained in a MAC-d PDU).

According to another aspect of the present invention, in AM and UM, the scheduler may select the MAC-d PDUs to be contained in the second MAC-hs PDU from the MAC-d PDUs of the original MAC-hs PDU by minimizing a number of logical channels which are affected by a loss of a MAC-d PDU. A channel is affected if one or more RLC PDUs (each contained in a single MAC-d PDU) belonging to the respective channel is lost. This may, according to an aspect of the present invention, be achieved by selecting the MAC-d PDUs to be contained in the second MAC-hs PDU such that, for example, not two logical channels but only one logical channel loses RLC PDUs.

According to another aspect of the present invention, in AM and UM, the scheduler may also send after the abortion of the transmission of a MAC-hs PDU a second MAC-hs PDU, which is empty, and uses the sequence number of the aborted MAC-hs PDU, i.e. the scheduler selects none of the MAC-d PDUs contained in the aborted MAC-hs PDU for transmission in the second MAC-hs PDU. Transmission of an empty MAC-hs PDU may be helpful, if the reordering entity in the MAC-hs layer on the receiving side needs to know the sequence number of the aborted MAC-hs PDU for optimized operation.

According to another exemplary embodiment of the present invention, the size of the second MAC-hs PDU can be kept equal to the size of the aborted MAC-hs PDU so that all MAC-d PDUs contained in the aborted MAC-hs PDU can be transmitted within the second MAC-hs PDU, which uses the same sequence number as the aborted MAC-hs PDU. The stronger FEC is achieved by choosing a higher modulation scheme and/or by choosing additional channelization codes so that a higher number of physical layer bits can be transmitted via the air interface.

According to a further aspect of the present invention it may even occur that all MAC-d PDUs of the original MAC-hs PDU, the transmission of which has been aborted, may be “retransmitted” in newly composed, smaller MAC-hs PDUs. According to an aspect of the present invention this may be achieved, when the MAC-hs sequence numbers, which are necessary for doing that, have not yet been used in a successful transmission of the MAC-hs PDUs on other HARQ processes. This may, in particular, be the case, when on another HARQ process an abortion of a transmission has occurred. According to the present invention, the scheduler is arranged such that it identifies such subsequent sequence numbers which have not been used in a subsequent transmission of MAC-hs PDUs and assigns these subsequent sequence numbers to further new containers, i.e. MAC-hs PDUs which have a smaller size and which contain a reduced number of MAC-d PDUs in comparison to the originally transmitted MAC-hs PDU which has been aborted.

In order to achieve the above functions, according to the present invention, one or more of the following pieces of information may be provided by the RNC to the scheduler in the MAC-hs layer on the Node B:

The logical channels may be operated in UM. Since the HS-DSCH can carry only UM logical channels and AM logical channels, this information therefore also indicates the AM logical channels.

The assignment of the MAC Logical Priority (MLP) to the logical channels.

A structure of a length indicator for determining a MAC-d PDU, the transmission of which is urgent.

Providing one or more of the above mentioned pieces of information can be done as follows: When setting up a UM logical channel, the data of which is to be carried via the HS-DSCH, the SRNC notifies, via an RNSAP-procedure, the DRNC of one or more of these pieces of information, which the DRNC then forwards to the Node B by an NBAP procedure. RNSAP procedures and NBAP procedures, which are most suited for this, have the same name, and are called

Radio Link Setup Procedure (the corresponding message sent from the SRNC to the DRNC or from the DRNC to the Node B is called “RADIO LINK SETUP”)

Synchronised Radio Link Reconfiguration Preparation Procedure (the corresponding message sent from the SRNC to the DRNC, in case of the RNSAP, or from the DRNC to the Node B, in case of the NBAP, is called “RADIO LINK RECONFIGURATION PREPARE”).

RNSAP (Radio Network System Application Part) is described in 3GPP TS 25.423 V5.3.0 (2002-09), 3rd Generation Partnership Project; Technical Specification Group Radio Access Network; UTRAN Iur Interface RNSAP Signalling (Release 5).

NBAP (Node B Application Part) is described in 3GPP TS 25.433 V5.2.0 (2002-09), 3rd Generation Partnership Project; Technical Specification Group Radio Access Network; UTRAN Iub interface NBAP signaling (Release 5). Both specifications are hereby incorporated by reference.

FIG. 4 shows a simplified representation of a method according to an exemplary embodiment of the present invention.

As may be taken from FIG. 4, after the start in step S1, it is determined in the subsequent step S2 whether a MAC-hs PDU transmission with sequence number x is aborted. In case it is determined in step S2 that a transmission abortion occurred, the method continues to step S3 where suitable MAC-d PDUs are selected from the MAC-d PDUs contained in the MAC-hs PDU with the sequence number x, the transmission of which was aborted. This selection may be carried out as described above.

In the subsequent step S4, according to the present invention, a new MAC-hs PDU containing only the suitable MAC-d PDUs selected in step S3 is formed. This new MAC-hs PDU is provided with the sequence number x, i.e. with the same sequence number as the original MAC-hs PDU, the transmission of which was aborted. Then, in the subsequent step S5, the MAC-hs PDU with the sequence number x is transmitted to the receiver. Then, the method ends in step S6.

In case it is determined in step S2 that there is no transmission abortion, the method continues from step S2 to step S6 where it ends.

1. Method of transmitting first data packets from a transmitter to a receiver, wherein the first data packets are transmitted from the transmitter to the receiver in containers, wherein each of the containers is provided with a sequence number, the method comprising the steps of: determining a transmission abortion where a transmission of a first container which comprises a first number of second data packets of the first data packets is aborted; wherein the first container is provided with a first sequence number; selecting a second number of third data packets from the first number of second data packets; wherein the first number is larger than the second number; forming a second container comprising the second number of third data packets; and transmitting the second container with the first sequence number.

2. The method of claim 1, wherein a third number of fourth data packets which are left over when forming the second number of third data packets, is deleted.

3. The method of claim 1, wherein the second container provides stronger forward error correction than the first container.

4. The method of claim 1, wherein the third data packets are selected from the second data packets on the basis of the order of the second data packets according to which they are arranged in the first container.

5. The method of claim 1, wherein the third data packets are selected from the second data packets in accordance with an urgency with which they are required at the receiver.

6. The method of claim 1, wherein the second and third data packets are service data units of a first protocol layer, which forms the first and second containers; wherein the first, second and third data packets are segmented from a plurality of fifth data packets in the transmitter; wherein the fifth data packets are service data units of a second protocol layer which is at a level above the first protocol layer; wherein sixth data packets are received at the receiver; wherein the fifth data packets are rebuilt from selected ones of the sixth data packets; and wherein the third data packets are selected such that the fifth data packets can be rebuilt at the receiver.

7. The method of claim 1, wherein the second and third data packets are service data units of a first protocol layer, which forms the first and second containers; wherein the first, second and third data packets are segmented from a plurality of fifth data packets in the transmitter; wherein the fifth data packets are service data units of a second protocol layer which is at a level above the first protocol layer; wherein the third data packets are selected such that they belong to fifth data packets for which seventh data packets have been received earlier at the receiver.

8. The method of claim 1, wherein the third data packets are selected from the second data packets at random.

9. The method of claim 1, wherein the third data packets are selected from the second data packets such that a loss of synchronization of a serial number, which forms a time varying input for a ciphering and deciphering, between the transmitter and the receiver is avoided.

10. The method of claim 1, wherein the third data packets are selected such that a third number of logical channels affected by the reduction of the first number of second data packets to the second number of third data packets is minimized.

11. The method of claim 1, wherein the second data packets which were not selected as third data packets are transmitted to the receiver in a third container with a third sequence number.

12. The method of claim 1, wherein the method is applied for a control of a retransmission of the HARQ protocol on the High Speed Downlink Shared Channel in UMTS.

13. Data transmission system for transmitting first data packets from a transmitter to a receiver, wherein the first data packets are transmitted from the transmitter to the receiver in containers, wherein each of the containers is provided with a sequence number, wherein the data transmission system is adapted to perform the following operation: determining a transmission abortion where a transmission of a first container which comprises a first number of second data packets of the first data packets is aborted; wherein the first container is provided with a first sequence number; selecting a second number of third data packets from the first number of second data packets; wherein the first number is larger than the second number; forming a second container comprising the second number of third data packets; and transmitting the second container with the first sequence number.

14. A transmitter for a data transmission system, wherein the transmitter is adapted to transmit first data packets to a receiver, wherein the first data packets are transmitted from the transmitter to the receiver in containers, wherein each of the containers is provided with a sequence number, wherein the transmitter is adapted to determine a transmission abortion where a transmission of a first container which comprises a first number of second data packets of the first data packets is aborted; wherein the first container is provided with a first sequence number; select a second number of third data packets from the first number of second data packets; wherein the first number is larger than the second number; form a second container comprising the second number of third data packets; and transmit the second container with the first sequence number to the receiver.

15. A receiver for a data transmission system, wherein the receiver is adapted to receive first data packets transmitted from a transmitter, wherein the first data packets are transmitted from the transmitter to the receiver in containers, wherein each of the containers is provided with a sequence number, wherein a first container has been received by the receiver including a first number of second data packets, the first container having a first sequence number; wherein the receiver is adapted to receive a second container including a second number of second data packets; wherein the first number is larger than the second number; wherein the second container has the first sequence number.

16. A software program for performing a transmission of first data packets from a transmitter to a receiver, wherein the first data packets are transmitted from the transmitter to the receiver in containers, wherein each of the containers is provided with a sequence number, the software program performing the steps of: determining a transmission abortion where a transmission of a first container which comprises a first number of second data packets of the first data packets is aborted; wherein the first container is provided with a first sequence number; selecting a second number of third data packets from the first number of second data packets; wherein the first number is larger than the second number; forming a second container comprising the second number of third data packets; and transmitting the second container with the first sequence number.
